(19) United States
(12) Patent Application Publication
(10) Pub. No.: US 2025/0198118 A1
(43) Pub. Date: Jun. 19, 2025

(54) ROLL COMPACTOR ATTACHMENT FOR LOADER

(71) Applicant: PACKMAT EQUIPMENT, St-Jean-sur-Richelieu (CA)

(72) Inventor: Eric BOIVIN, Levis (CA)

(21) Appl. No.: 18/847,974

(22) PCT Filed: Mar. 17, 2023
(86) PCT No.: PCT/CA2023/050355

§ 371 Date: Sep. 17, 2024

Related U.S. Application Data
(60) Provisional application No. 63/320,959, filed on Mar. 17, 2022.

(51) Int. Cl. E02F 3/96; B09B 3/32; E02F 3/36; E02F 3/38

(52) U.S. Cl. CPC E02F 3/967; B09B 3/32; E02F 3/3604; E02F 3/38

(57) ABSTRACT

A roll compactor attachment for a loader has a first arm having a first end portion configured for connecting to a boom assembly of the loader; a second arm having a first end portion pivotally connected to a second end portion of the first arm; a third arm having a first end portion pivotally connected to a second end portion of the second arm; a roller rotationally connected to a second end portion of the third arm; a roller actuator operatively connected to the roller for turning the roller; and a stopper connected to one of the first and second arms. The stopper selectively abuts another one of the first and second arms to limit a minimum angle between the first and second arms. A roll compactor attachment having a lock selectively locking the first arm to the third arm is also disclosed.

### CROSS-REFERENCE

The present application claims priority to U.S. Provisional Patent Application No. 63/320,959, filed Mar. 17, 2022, the entirety of which is incorporated herein by reference.

### TECHNICAL FIELD

The present technology relates to roll compactor for compacting waste, and more specifically to roll compactors attachments used for compacting waste in open top waste containers for use with loaders.

### BACKGROUND

Open top waste containers are often used on constructions sites, at factories, warehouses and other businesses to receive various waste. When a container is full, it is picked up by a truck and hauled to a landfill or other waste disposal site to be emptied. The emptied container is then returned to the original site or another site to be filled again.

The costs associated with such pick-up and emptying services are typically not associated with the weight of the waste in the container. Even in cases where the weight of the waste is considered in the cost of the service, there is a portion of the cost associated with the act of picking-up and emptying the open top waste container. As such, there is an incentive for users of open top waste container to put as much waste as possible in the waste container before having it picked-up for emptying.

Mobile waste compactors have been developed to address this issue. These can be deployed to the locations of the open top waste containers and compact the waste in the containers. As such, the volume of waste in the container is reduced and more waste can then be added to the container before the container needs to be picked-up and emptied. As a result, the containers need to be picked-up less often. Although there is a cost associated with the deployment of such mobile waste compactors, since the waste containers do not need to be picked-up as often, the overall cost is reduced.

Some mobile waste compactors are referred to as mobile roll compactors. In roll compactors, a roller is connected to the end of articulated arm assembly mounted to the back of a truck. In some embodiments, one or more actuators are used to deploy the articulated arm assembly to an operational position, one or more other actuators are used to move two articulated arms of the articulated arm assembly relative to each other, and one or more other actuators are used to turn the roller and cause it to travel over the waste in the open top container to compact the waste. The high number of actuators increase the cost, complexity and weight of the roll compactor.

Most mobile roll compactors are vehicles specifically designed to be mobile roll compactors. This can make the cost of acquiring a mobile roll compactor prohibitively high.

Therefore, there is a desire for a mobile roll compactor that can overcome at least some of the above-described drawbacks.

### SUMMARY

It is an object of the present technology to ameliorate at least some of the inconveniences present in the prior art.

According to the present technology, there is provided a roll compactor attachment that can be mounted to a boom assembly of a loader in a manner similar to other attachments, such as buckets and forks, that are to be provided on a loader. As such, this reduces the cost of acquisition of a mobile roll compactor as only the attachment needs to be acquired should the customer already own a loader to which the roll compactor attachment can be connected, thereby making a mobile roll compactor. The design of a roll compactor attachment needs to take into account various constraints, including, but not limited to, the range of motion of the boom assembly of the loader, the required range of motion of the roller in order to reach most areas in an open top container, and the maximum weight that can be carried by the loader at the end of its boom assembly and avoid any configuration where a combination of weight and distance could cause the loader to tilt forward. The roll compactor attachment has first, second and third arms pivotally connected to each other. The first arm is configured to be attached to the boom assembly of a loader. A roller is connected to the third arm. A stopper limits a minimum angle between the first and second arms, thus allowing the roller to be lifted in and out of an open top container by the loader without requiring an actuator between the first and second arms. A lock selectively connects the first and third arms to each other, thus allowing the loader to move with the roll compactor attachment without having the roller swinging.

According to one aspect of the present technology, there is provided a roll compactor attachment for a loader having a first arm having a first end portion configured for connecting to a boom assembly of the loader; a second arm having a first end portion pivotally connected to a second end portion of the first arm about a first pivot axis; a third arm having a first end portion pivotally connected to a second end portion of the second arm about at second pivot axis; a roller rotationally connected to a second end portion of the third arm; a roller actuator operatively connected to the roller for turning the roller; and a stopper connected to one of the first and second arms. The stopper selectively abuts another one of the first and second arms to limit a minimum angle between the first and second arms.

In some embodiments, the stopper is connected to the first arm and selectively abuts the second arm.

In some embodiments, the first arm has two pins for connecting the first arm to the boom assembly.

In some embodiments, the roller actuator is a rotary hydraulic motor.

In some embodiments, first hydraulic lines fluidly connect to the rotary hydraulic motor; a lock selectively locks the first arm to the third arm; a hydraulic lock actuator is operatively connected to the lock for unlocking the lock; and second hydraulic lines fluidly connect the first hydraulic lines to the hydraulic lock actuator.

In some embodiments, a lock selectively locks the first arm to the third arm.

In some embodiments, a first distance between a lower end of the first arm and the first pivot axis is smaller than a second distance between the first pivot axis and the second pivot axis. The first distance is smaller than a third distance between the second pivot axis and an axis of rotation of the roller.

In some embodiments, a first distance between a lower end of the first arm and the first pivot axis is smaller than a second distance between the first pivot axis and the second pivot axis. The second distance is smaller than a maximum distance between the second pivot axis and a circumference of the roller.

In some embodiments, the roller has a plurality of cutters.

According to another aspect of the present technology, there is provided a loader having a frame; a driver cabin mounted to the frame; at least four wheels operatively connected to the frame; a boom assembly pivotally mounted to the loader; and a roll compactor attachment according to one or more of the above embodiments selectively connected to the boom assembly.

According to another aspect of the present technology, there is provided a roll compactor attachment for a loader having a first arm having a first end portion configured for connecting to a boom assembly of the loader; a second arm having a first end portion pivotally connected to a second end portion of the first arm about a first pivot axis; a third arm having a first end portion pivotally connected to a second end portion of the second arm about at second pivot axis; a roller rotationally connected to a second end portion of the third arm; a roller actuator operatively connected to the roller for turning the roller; and a lock selectively locking the first arm to the third arm.

In some embodiments, a stopper is connected to one of the first and second arms. The stopper selectively abuts another one of the first and second arms to limit a minimum angle between the first and second arms.

In some embodiments, the first arm has two pins for connecting the first arm to the boom assembly.

In some embodiments, the roller actuator is a rotary hydraulic motor.

In some embodiments, first hydraulic lines fluidly connect to the rotary hydraulic motor; a hydraulic lock actuator operatively connects to the lock for unlocking the lock; and second hydraulic lines fluidly connect the first hydraulic lines to the hydraulic lock actuator.

In some embodiments, actuating the rotary hydraulic motor actuates the hydraulic lock actuator to unlock the lock.

In some embodiments, the lock comprises a hook connected to the first arm and a pin connected to the third arm. The hook selectively engages the pin to lock the first arm to the third arm.

In some embodiments, a first distance between a lower end of the first arm and the first pivot axis is smaller than a second distance between the first pivot axis and the second pivot axis. The first distance is smaller than a third distance between the second pivot axis and an axis of rotation of the roller.

In some embodiments, a first distance between a lower end of the first arm and the first pivot axis is smaller than a second distance between the first pivot axis and the second pivot axis. The second distance is smaller than a maximum distance between the second pivot axis and a circumference of the roller.

In some embodiments, the roller has a plurality of cutters.

According to another aspect of the present technology, there is provided a loader having a frame; a driver cabin mounted to the frame; at least four wheels operatively connected to the frame; a boom assembly pivotally mounted to the loader; and a roll compactor attachment according to one or more of the above embodiments selectively connected to the boom assembly.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 10%, and preferably within 5% of the given value or range.

As used herein, the term “generally vertical” refers to an orientation that is within 15 degrees from vertical, and preferably within 10 degrees from vertical, and includes a vertical orientation. As used herein, the term “generally horizontal” refers to an orientation that is within 15 degrees from horizontal, and preferably within 10 degrees from horizontal, and includes a horizontal orientation.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Definitions and explanations of terms provided in the present application take precedence over definitions and explanations of corresponding terms that may be found in any of the documents incorporated herein by reference.

Embodiments of the present technology each have at least one of the above-mentioned object and/or aspects, but do not necessarily have all of them. Some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, right side of a roll compactor attachment connected to a loader, with the roll compactor attachment being in a transport configuration;

FIG. 2 is a right side elevation view of the roll compactor attachment of FIG. 1, with the roll compactor attachment in a storage configuration on supports;

FIG. 3 is a left side elevation view of the roll compactor attachment and loader of FIG. 1, with the roll compactor attachment being in the transport configuration;

FIG. 4 is a left side elevation view of the roll compactor attachment and loader of FIG. 1, with the roll compactor attachment being lifted above an open top waste container, shown in transparency;

FIGS. 5 to 9 are left side elevation views of the roll compactor attachment and loader of FIG. 1 with the open top waste container, shown in transparency, showing the roll compactor attachment in various compacting configurations during the waste compaction process;

FIG. 10 is a schematic diagram of a hydraulic system of the roll compactor attachment;

FIG. 11 is a left side elevation view of an alternative embodiment the roll compactor attachment of FIG. 1 with the roll compactor attachment in a storage configuration on the ground; and

FIG. 12 is a close-up, left side elevation view of a portion of the roll compactor attachment of FIG. 10 showing a lock locking the two of the arms when the roll compactor attachment is in a transport configuration.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

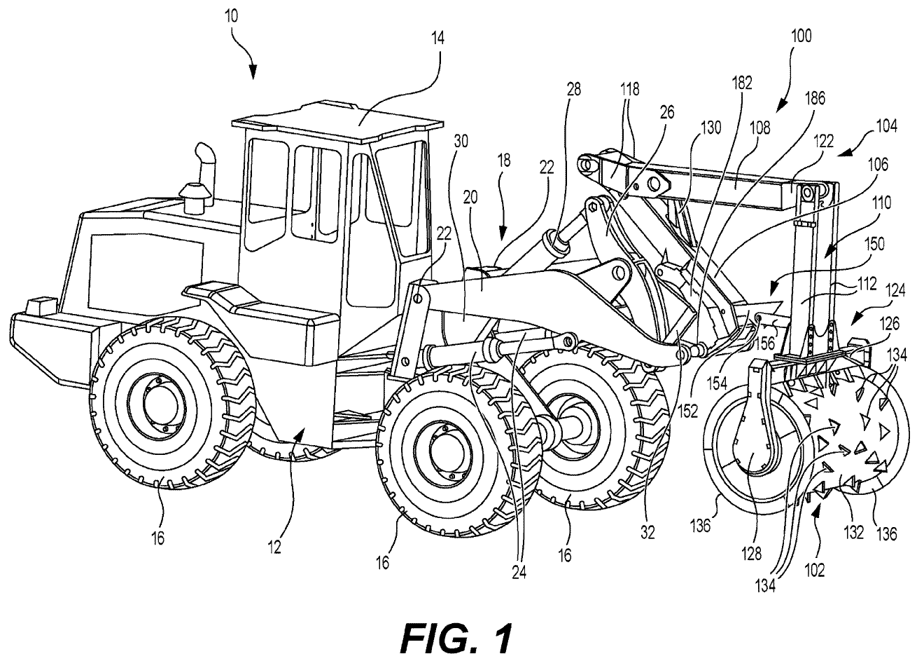

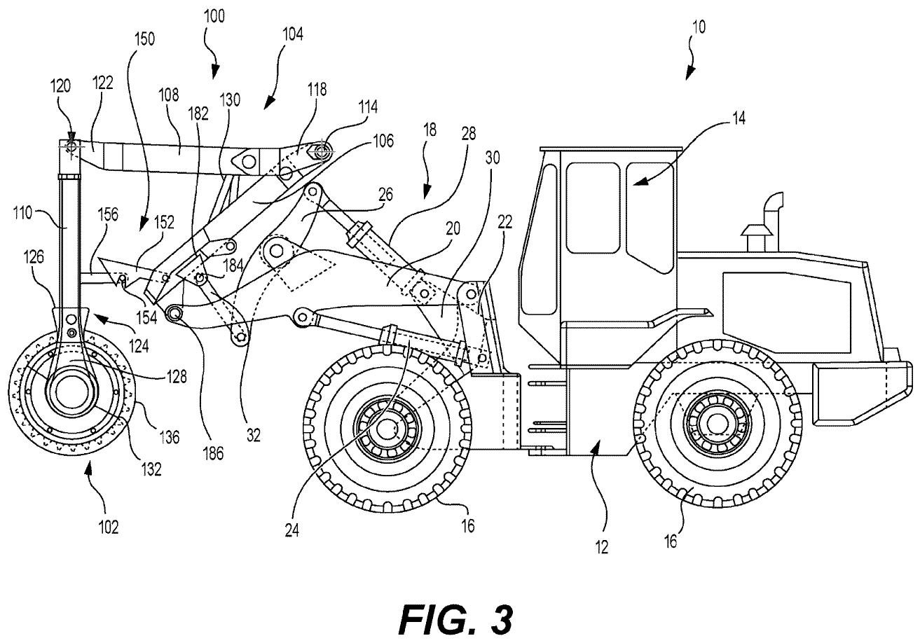

With reference to FIGS. 1 and 3, a loader 10 has a frame 12, a driver cabin 14 mounted to the frame 12, four wheels 16 operatively connected to the frame 12, and a boom assembly 18 pivotally connected to a front of the frame 12. It is contemplated that the loader 10 could have more than four wheels 16. It is also contemplated that the boom assembly 18 could be pivotally connected to a rear of the frame 12.

The boom assembly 18 has two booms 20 pivotally connected to two brackets 22 of the frame 12, and two hydraulic cylinders 24 pivotally connected between the booms 20 and the brackets 22. The front ends of the booms 20 are configured to be connected to different attachments. The hydraulic cylinders 24 raise and lower the fronts of the booms 20, which in turn raises and lowers the attachment connected to boom assembly 18. The boom assembly 18 also has a rocker arm 26 pivotally connected at or near its center between the booms 20, a hydraulic cylinder 28 pivotally connected between a bracket 30 of the frame 12 and one end of the rocker arm 26, and a link 32 pivotally connected to the other end of the rocker arm 26. The front end of the link 30 is also configured to be connected to different attachments. The hydraulic cylinder 28 pivots the rocker arm 26 and the link 30 which in turn tilts the attachment connected to the boom assembly 18. In the present embodiments, the attachment is a roll compactor attachment 100 that will be described in more detail below. However, the front ends of the booms 20 and the link 30 can also be connected to other attachments such as, but not limited to, a bucket and forks. In the present embodiment, changing one attachment attached to the boom assembly 18 for another attachment is done manually by an operator of the loader using tools. However, it is contemplated that the front ends of the booms 20 and the link 30 could be connected to a quick coupler which allows semi-automatic or automatic disconnection of attachments from the boom assembly 18 and connection of attachments to the boom assembly 18. In a semi-automatic quick coupler, most operations for connecting and disconnecting attachments can be controlled by the operator of the loader 10 from within the driver cabin 14, with some operations, such as the disengagement or engagement of a safety pin, being done manually. In an automatic quick coupler, all operations for connecting and disconnecting attachments can be controlled by the operator of the loader 10 from within the driver cabin 14.

The constructions of the loader 10 described above and illustrated in the accompanying Figures is one contemplated construction of a loader and other constructions are contemplated. Similarly, the constructions of the boom assembly 18 described above and illustrated in the accompanying Figures is one contemplated construction of a boom assembly and other constructions are contemplated.

With reference to FIGS. 1 to 3, the roll compactor attachment 100 includes a roller 102 and an articulated arm assembly 104 connected to the roller 102. The articulated arm assembly 104 has three arms 106, 108, 110. As can be seen in FIG. 1, the arm 110 is made from left and right arm portions 112. The arm 106 has an end portion configured to be connected to the boom assembly 18 as will be described in more detail below. The opposite end portion of the arm 106 is pivotally connected to an end portion of the arm 108 about a pivot axis 114 via brackets 116, 118. The opposite end portion of the arm 108 is pivotally connected to an end portion of the arm 110 about a pivot axis 120 via brackets 122. The opposite end portion of the arm 110 rotationally connects to the roller 102 via a roller support 124. As best seen in FIG. 1, the roller support 124 has a lateral member 126 connected to the end of the arm 110 and two legs 128 extending from the ends of the lateral member 126. The roller 102 is received between the legs 128 and is rotationally connected thereto.

The roll compactor attachment 100 also has a stopper 130. The stopper 130 is connected to the arm 106. The stopper 130 selectively abuts the arm 108 to limit a minimum angle between the arms 106, 108 as can be seen in FIGS. 1, 3 and 4. It is contemplated that the stopper 130 could be connected to the arm 108 to selectively abut the arm 106.

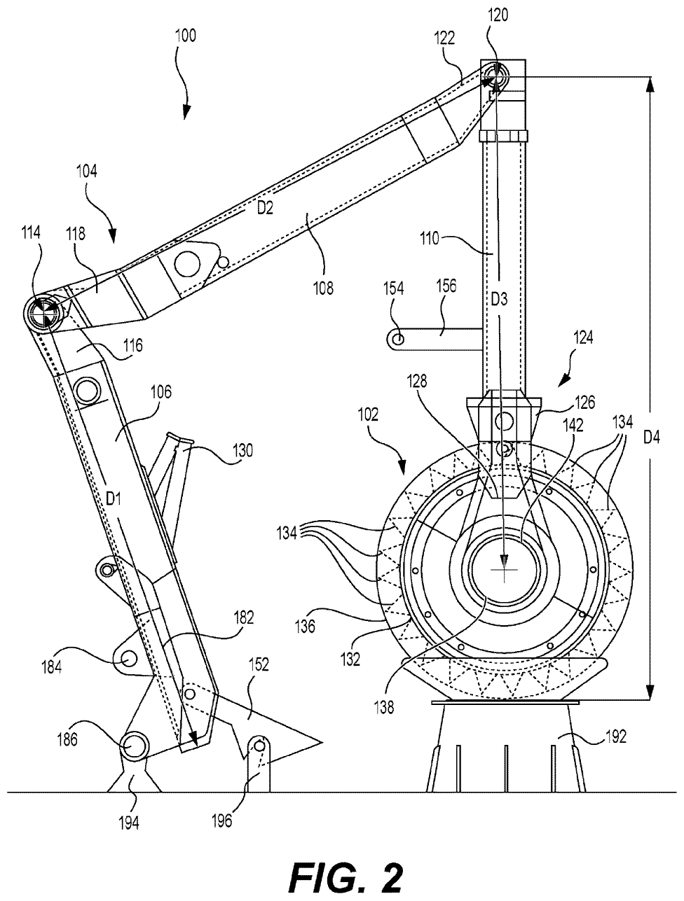

With reference to FIG. 1, the roller 102 has a cylindrical drum 132 with a plurality of cutters 134 provided on its surface (only some of which are labeled). Flanges 136 are provided at either end of the drum 132. A roller actuator 138 is connected to the roller 102 to turn the roller 102. In the present embodiment, the roller actuator 138 is a rotary hydraulic motor 138 disposed in part inside the drum 132 (as schematically shown in FIG. 2). The rotary hydraulic motor 138 is connected to the drum 132 and to the legs 128 in order to rotate the roller 102. The rotary hydraulic motor 138 is powered by a hydraulic pump (not shown) provided on the loader 10. The hydraulic pump is driven by an engine (not shown) of the loader 10. It is contemplated that there could be two roller actuators 138 (i.e., one per leg 128). It is contemplated that in some embodiments, the roller actuator 138 could be of a different type, such as an electric motor for example. In some embodiments, cement or another heavy material is provided inside the drum 132 of the roller 102 to increase the weight of the roller 102. In some embodiments, the combined weight of the roller 102, the roller actuator 138 and the effective weight of the articulated arm assembly 104 (i.e. the weight of the articulated arm assembly 104 borne by the roller 102 during compaction) is at least 450 kilograms. This combined weight is the weight having an effect on compaction. In other embodiments, this combined weight is at least 2000 kilograms.

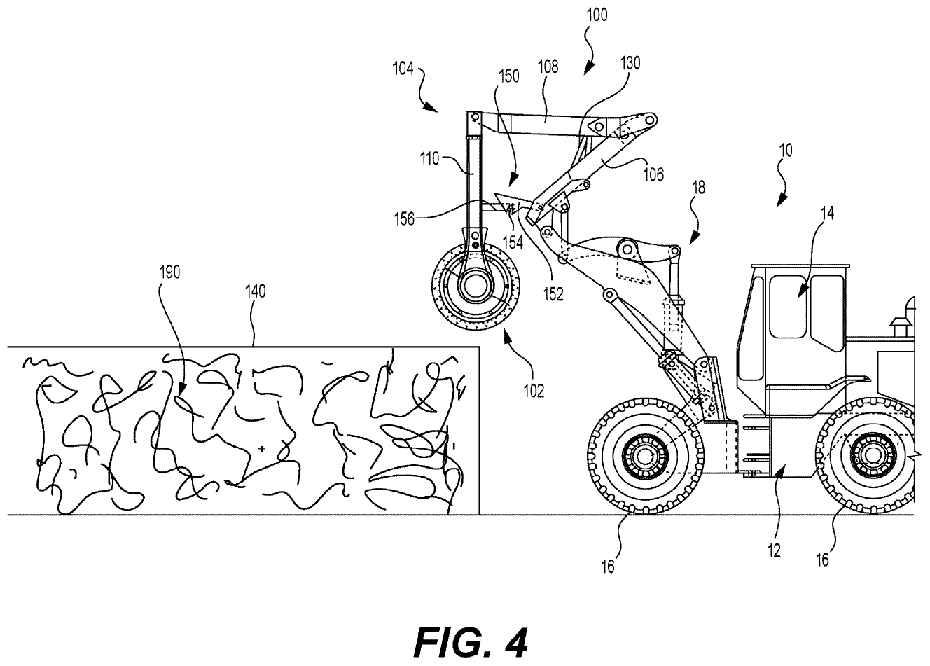

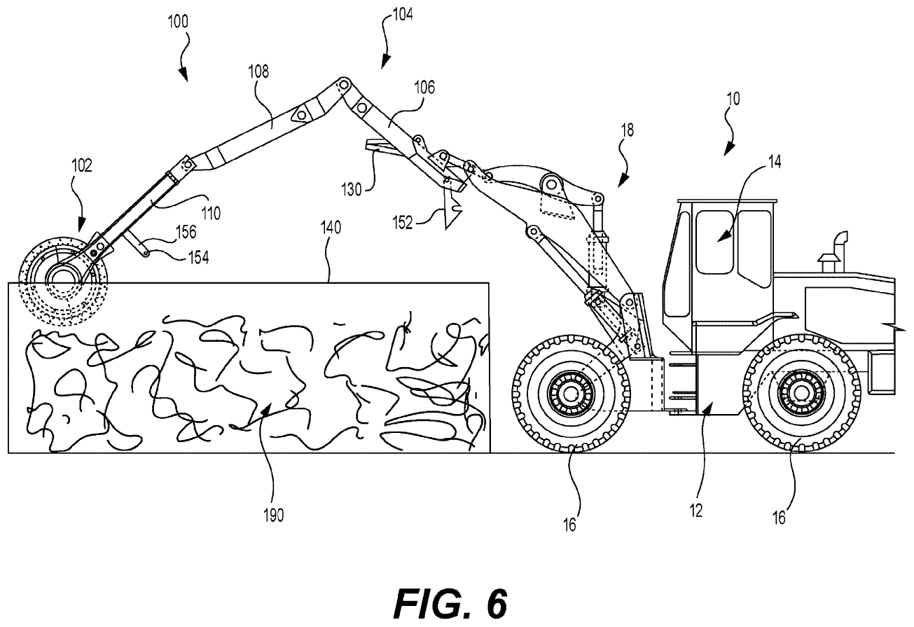

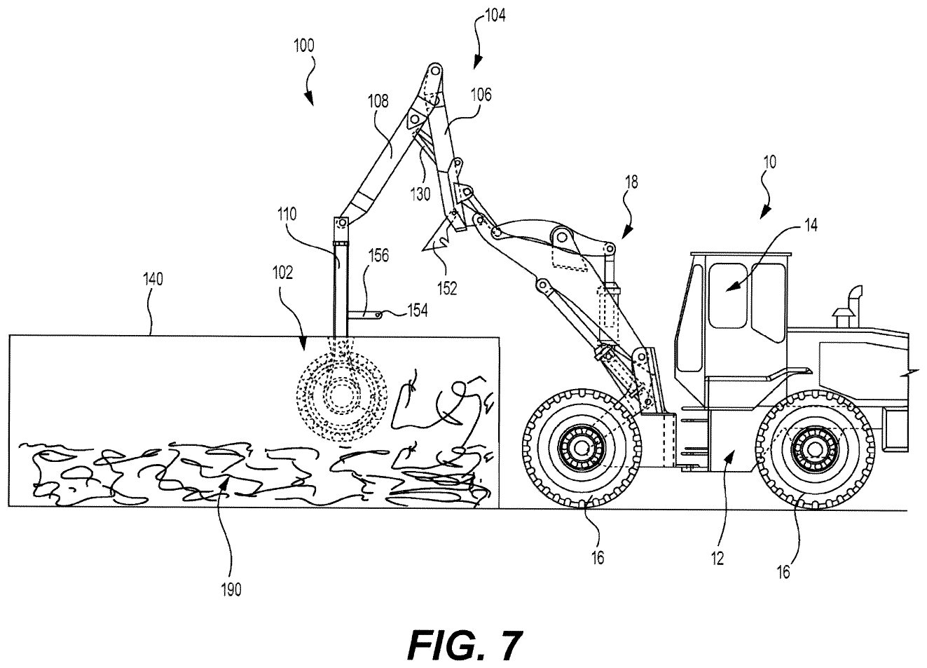

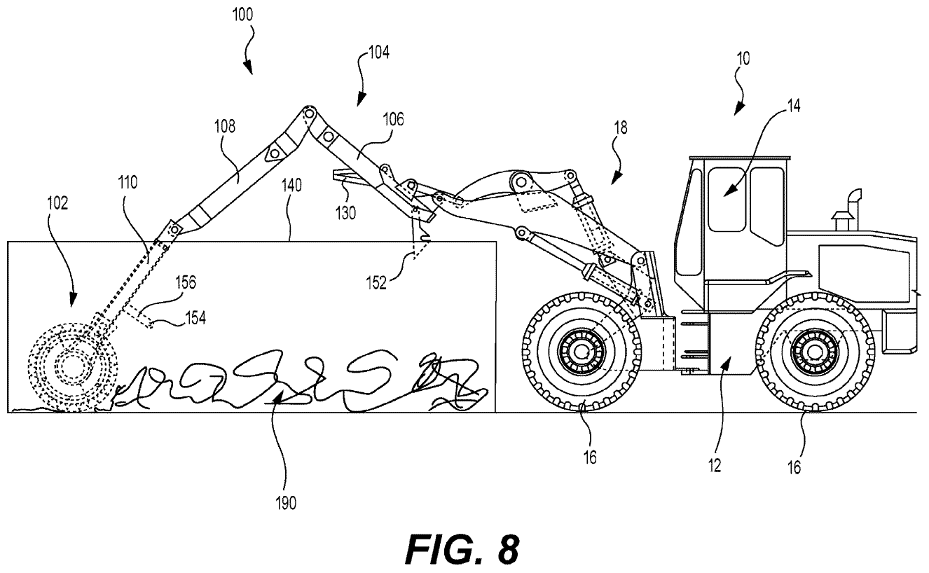

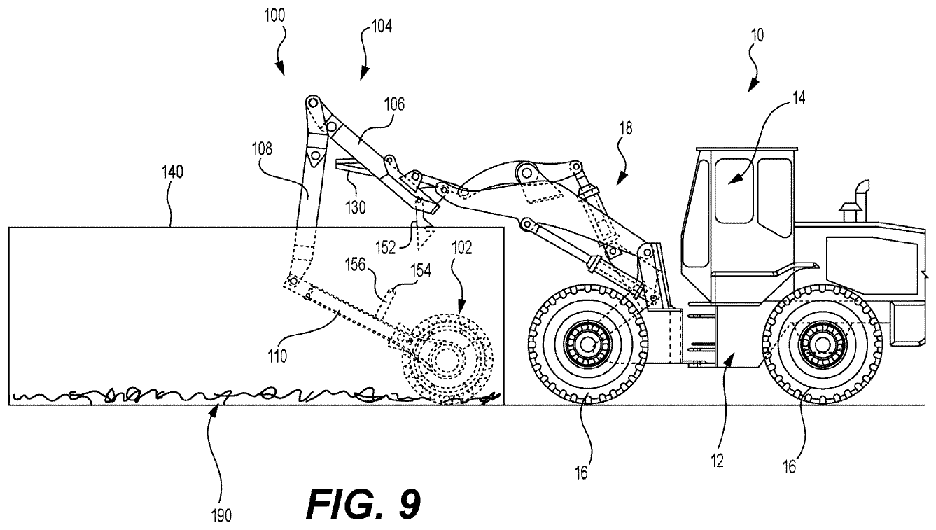

The dimensions of the arms 106, 108, 110 and the roller 102 should be selected such that: the loader 10 with the roll compactor attachment 100 connected thereto can put the roller 102 into an open top container 140 (FIGS. 4 to 9), the roller 102 can reach almost all areas in the open top container 152 from front to back and top to bottom, and the loader 10 will not tip over due to the torque applied by the roll compactor attachment 100 when the roller 102 is lifted off the ground. Many factors have to be considered including, but not limited to: the weight of the roll compactor assembly 100 as a whole, the weight of the roller 102, the dimensions of the open top container 140, the maximum height at which the boom assembly 18 can lift the roll compactor attachment 100, and the range of angles through which the boom assembly 18 can tilt the roll compactor attachment 100. In order to prevent the loader from tipping over, the roll compactor attachment 100 is designed such that the torque caused by the roll compactor attachment 100 about the axles of the front wheels 16 for any position of the roller 102 (i.e. a counter-clockwise torque in FIGS. 3 to 9) is less than a torque caused by the weight of the loader 10 about the axles of the front wheels 16 (i.e. a clockwise torque in FIGS. 3 to 9). FIG. 7 illustrates one of the configurations of the boom assembly 18 and the roll compactor attachment 100 where, when the roller 102 is not resting on anything, the torque caused by the roll compactor attachment 100 about the axles of the front wheels 16 is highest. With reference to FIG. 2, in the present embodiment: a distance D1 between a lower end of the arm 106 and the pivot axis 114 is smaller than a distance D2 between the pivot axis 114 and the pivot axis 120; the distance D1 is smaller than a distance D3 between the pivot axis 120 and an axis of rotation 142 of the roller 102; and the distance D2 is smaller than a maximum distance D4 between the pivot axis 120 and a circumference of the roller 102.

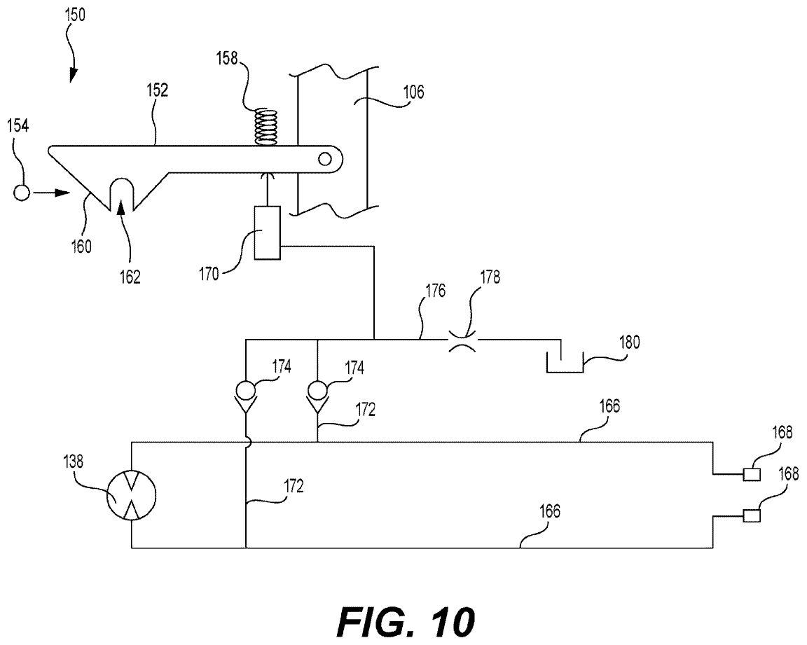

The roll compactor attachment 100 also has a lock 150 to selectively lock the arm 106 to the arm 110. When the lock 150 locks the arm 106 to the arm 110, the roller 102 is prevented from swinging about the pivot axis 120, thereby facilitating movement of the loader 10 with the roll compactor attachment 100 between locations where the roll compactor attachment 100 is to be used. In the present embodiment, with reference to FIG. 2, the lock 150 includes a hook 152 connected to a lower portion of the arm 106 that selectively engages a pin 154 connected to the arm 110 by an arm 156. More specifically, the arm 156 is connected between the left and right arm portions 112 of the arm 110. The hook 152 is pivotally connected to the arm 106 and is biased downward by a spring 158 as can be seen in FIG. 10. With reference to FIG. 10, it can be seen that a front surface 160 of the hook 152 is angled. As such, as the hook 152 and the pin 154 are moved toward each other, as will be described in more detail below, the pin 154 abuts the surface 160 of the hook 152 thereby pivoting the hook 152 upward, until the pin 154 is aligned with a downwardly opening recess 162 defined in the hook 152. When the pin 154 is aligned with the recess 162, the spring 158 pivots the hook 152 down such that the pin 154 is received in the recess 162 such that the lock 150 is locked. The biasing force of the spring 158 prevents the hook 152 from accidentally disengaging the pin 154.

With reference to FIG. 10, the rotary hydraulic motor 138 is fluidly connected to two hydraulic lines 166. The hydraulic lines 166 have connectors 168 at their ends to connect to the hydraulic pump of the loader 10 when the roll compactor attachment 100 is connected to the boom assembly 18. To unlock the lock 150, a hydraulic lock actuator 170 is connected to the hook 152. The hydraulic lock actuator 170 is connected to the hydraulic lines 166 by two hydraulic lines 172 having check valves 174. In the present embodiment, the hydraulic lock actuator 170 is a linear hydraulic cylinder, but other types of hydraulic actuators are contemplated. A hydraulic line 176 having a restriction 178 is fluidly connected between the check valves 174 and the hydraulic lock actuator 170 at one end and is fluidly connected to a hydraulic fluid reservoir 180 at the other end. The hydraulic fluid reservoir 180 is provided on the loader 10 to supply fluid to the hydraulic pump of the loader 10. When hydraulic fluid is supplied to the rotary hydraulic motor 138 via one line 166 and returned from the rotary hydraulic motor 138 via the other line 166, the check valves 174 open thereby supplying hydraulic fluid to the hydraulic lock actuator 170. As a result, the hydraulic lock actuator 170 lifts the hook 152 allowing the pin 154 to disengage the hook 152 and to unlock the lock 150. Since the lock 150 is unlocked whenever the rotary hydraulic motor 138 is actuated, this helps prevent damage to the roll compactor attachment 100 that may result from rolling the roller 102 while the lock 150 is locked. Should the rotary hydraulic motor 138 continue to be actuated by the hydraulic fluid supplied by one of the lines 166 after the hydraulic lock actuator 170 has reached the end of its travel, the excess hydraulic fluid is supplied to the reservoir 180 via the line 176. When hydraulic fluid stops to be supplied to the rotary hydraulic motor 138 via either one of the lines 166, the check valves 174 close, the spring 258 pushes down on the hook 152 which causes the hydraulic lock actuator 170 to retract, and hydraulic fluid flows from the hydraulic lock actuator 170 to the reservoir 180 via the line 176. It is contemplated that the lock 150 could unlocked by a different type of actuator. For example, it is contemplated that the hydraulic lock actuator 170 could be replaced by an electric motor or by a solenoid.

To permit attachment of the roll compactor attachment 100 to the boom assembly 18 of the loader 10, the arm 106 has a bracket 182 connected to a lower portion of the arm 106. The arm 106 also has two pins 184, 186 passing through the bracket 182. To attach the bracket 182 to the boom assembly 18, the pin 184 is inserted through an aperture in the link 32 and through the bracket 182, and the booms 20 are connected to the pin 186.

A method for compacting waste 190 in the open top container 140 with the roll compactor attachment 100 will be described. The open top container 140 has four lateral sides and a bottom. The top of the container 140 is open, hence the name open top container 140. It is contemplated that the open top container 140 could have a lid to selectively close the top of the open top container 140. As such, for purposes of the present application, an open top container 140 is a container which has a top that is permanently open or selectively open. The maximum width of the roller support 124 is narrowed than an inside width of the open top container 140.

The roll compactor attachment 100 is initially disconnected from the boom assembly 10 and is in a rest configuration as shown in FIG. 2. As shown in FIG. 2, in the rest configuration, the roller 102 is supported by a support 192, the pin 186 is supported by a support 194, and the hook 152 engages a bar 196. In the rest configuration, the stopper 130 does not abut the arm 108 and the lock 150 is unlocked (i.e. the hook 152 does not engage the pin 154). The loader 10 is moved near the arm 106 and the operator of the loader 10 operates the boom assembly 18 to connect the boom assembly 18 to the bracket 182 of the arm 106 as described above. The hydraulic pump of the loader 10 is then connected to the connectors 168 of the hydraulic lines 166. The operator of the loader 10 then operates the boom assembly 18 to lift the arm 106 such that the pin 186 and the hook 152 no longer rest of the support 194 and the bar 196 respectively. The operator of the loader 10 then operates the boom assembly 18 to move the hook 152 toward the pin 154 until the hook 152 engages the pin 152 thereby locking the arm 106 to the arm 110. The operator of the loader 10 then operates the boom assembly 18 to tilt back the arm 106 and to lift the roll compactor attachment 100 such that the roller 102 no longer rests on the support 192. As a result, the roll compactor attachment 100 is in a transport configuration, as shown in FIGS. 1 and 3, where the lock 150 locks the arm 106 to the arm 110 to prevent the roller 102 from swinging and where the stopper 130 abuts the arm 108. In the transport configuration of the roll compactor attachment 100, the operator of the loader 10 can drive the loader 10 to a location where the roll compactor attachment 100 can be used to compact the waste in an open top container such as waste 190 of the open top container 140. It is contemplated that the roll compactor attachment 100 could initially rest on the ground instead of on the supports 192, 194 and the bar 196, but the boom assembly 18 of the loader 10 would be connected to the roll compactor attachment 100 and would place the roll compactor attachment 100 in the transport configuration in a manner similar to the one described above.

The loader 10 is then driven to place the roll compactor attachment 100 next to the open top container 140. The operator of the loader 10 then operates the boom assembly 18 to lift the roll compactor attachment 100 such that the roller 102 is higher than the top of the open top container 140 and then drives the loader 10 forward such that the roller 102 passes over the top of the open top container 140 as shown in FIG. 4.

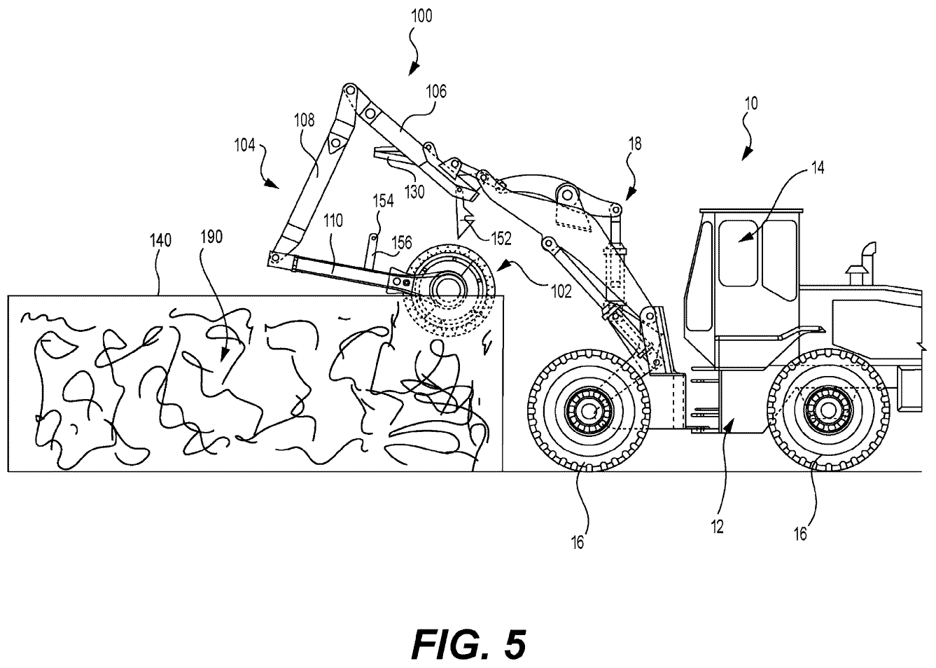

The operator of the loader 10 then operates the boom assembly 18 to lower the roller 102 onto the waste 190 in the open top container 140. The operator of the loader 10 then operates the boom assembly 18 to tilt the arm 106 forward and operates the rotary hydraulic motor 138 to roll the roller 102 which, as explained above, also causes the hydraulic lock actuator 170 to unlock the lock 150. The roller 102 is then rolled back and forth over the waste 190 present in the open top container 140, using the rotary hydraulic motor 138. As the roller 102 is rolled over the waste 190, the arms 108, 110 move to follow the roller 102 and the position of the arm 106 can be adjusted by the operator by operating the boom assembly 18 as needed. With each pass of the roller 102, the waste 190 gets gradually more and more compacted under the weight of the roller 102 as can be seen by comparing FIGS. 5 to 9. In FIGS. 5 to 9, the waste 190 is shown as being extremely compressible to show that the roll compactor attachment 100 is configured such that the roller 102 can reach almost all areas in the open top container 140 from front to back and top to bottom. Depending on the type of waste 190, with the container 140 being initially full, it may only be possible to compact the waste 190 by less than 50 percent of its initial volume, or less than 75 percent of its initial volume.

Once the waste 190 is compacted, the arm 106 is tilted back by the boom assembly 18 until the stopper 130 abuts the arm 108. As a result of the arm 106 being tilted back, once the arm 110 is vertical or nearly vertical, the hook 152 engages the pin 154 such that the lock 150 locks the arm 106 to the arm 110. The operator of the loader 10 then operates the boom assembly 18 to lift the roll compactor attachment 100 such that the roller 102 is higher than the top of the open top container 140 and then drives the loader 10 rearward such that the roller 102 passes over the top of the open top container 140. The operator of the loader 10 then operates the boom assembly 18 to put the roll compactor attachment 100 back in the transport configuration shown in FIGS. 1 and 3. The loader 10 with roll compactor attachment 100 can then be driven off to the next open top container 140 that requires the waste 190 contained therein to be compacted.

When the operator of the loader 10 desires to use an attachment other that the roll compactor attachment 100, such as a bucket for example, the operator operates the boom assembly 18 to put the roll compactor attachment 100 on the ground or on the supports 192, 194 and the bar 196 in the rest configuration. The hydraulic pump of the loader 10 is then disconnected from the connectors 168 of the hydraulic lines 166. The boom assembly 18 can then be disconnected from the pins 184, 186 and therefore from the roll compactor attachment 100.

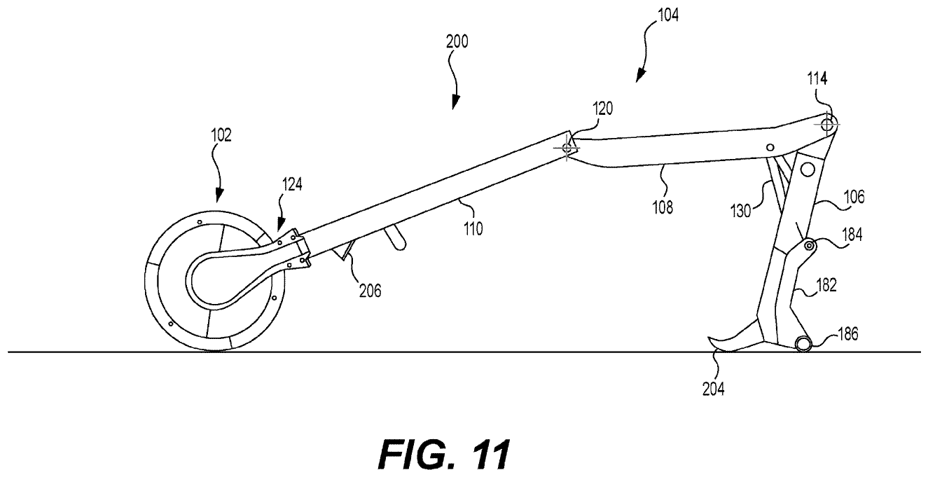

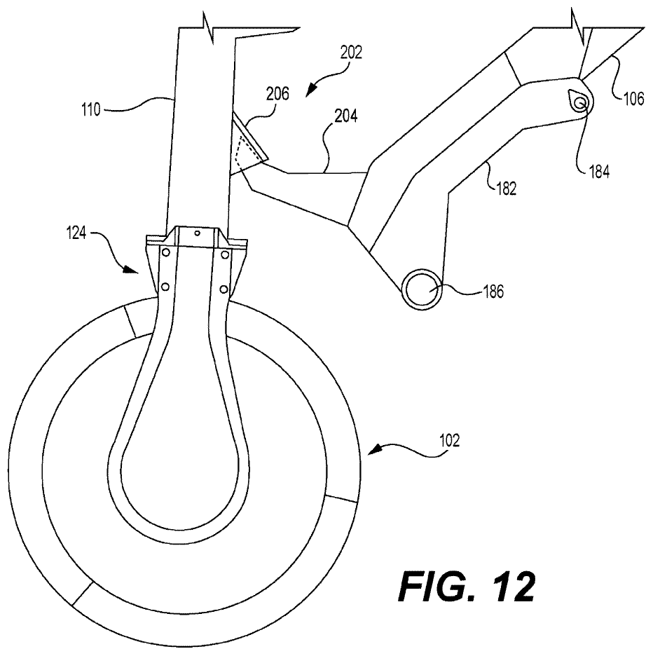

Turning now to FIGS. 11 and 12, an alternative embodiment of the roll compactor attachment 100 will be described. For simplicity, elements of this alternative embodiment that are similar to those of the roll compactor attachment 100 will not be described again in detail.

FIGS. 11 and 12 show a roll compactor attachment 200 that is the same as the roll compactor attachment 100 except that the lock 150 has been replaced by a lock 202. The lock 202 includes a hook 204 connected to a lower portion of the arm 106 and a pocket 206 connected to a lower portion of the arm 110. To lock the arm 106 to the arm 110, with the roller 102 on the ground, the operator of the loader 10 operates the boom assembly 18 to first move the tip of the hook 204 under the pocket 206 and then up into the pocket 206 as shown. To disengage the hook 204 from the pocket 206, the operator of the loader 10 operates the boom assembly 18 to first place the roller 102 onto a surface such as the ground, a support like the support 192 of FIG. 2, or on top of the waste 190 in the open top container 140, and then to move the hook 204 out of the pocket 206. Once compaction of the waste 190 in the open top container 140 is completed, the operator of the loader 10 operates the boom assembly 18 to remove the roller 102 from the open top container 140 and to lower the roller 102 onto the ground where the hook 204 can then be engaged with the pocket 206 as described above. Other than the way in which the lock 202 operates, the roll compactor attachment 200 can be used to compact waste 190 in the same manner as the one described above with respect to the roll compactor attachment 100.

It is contemplated locks other than the locks 150 and 202 could be used to lock the arm 106 to the arm 110. For example, a lock having an actuatable clamp and a ring could be used. In such an embodiment, the clamp is connected to the arm 106 and the ring is connected to the arm 110. To lock this lock, the clamp is opened and then moved toward the ring and once the ring is in the clamp, the clamp is closed thereby capturing the ring in the clamp.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A roll compactor attachment for a loader comprising:
a first arm having a first end portion configured for connecting to a boom assembly of the loader;
a second arm having a first end portion pivotally connected to a second end portion of the first arm about a first pivot axis;
a third arm having a first end portion pivotally connected to a second end portion of the second arm about at second pivot axis;
a roller rotationally connected to a second end portion of the third arm;
a roller actuator operatively connected to the roller for turning the roller; and
a stopper connected to one of the first and second arms, the stopper selectively abutting another one of the first and second arms to limit a minimum angle between the first and second arms.

2. The roll compactor attachment of claim 1, wherein the stopper is connected to the first arm and selectively abuts the second arm.

3. The roll compactor attachment of claim 1, wherein the first arm has two pins for connecting the first arm to the boom assembly.

4. The roll compactor attachment of claim 1, wherein the roller actuator is a rotary hydraulic motor.

5. The roll compactor attachment of claim 4, further comprising:
first hydraulic lines fluidly connected to the rotary hydraulic motor;
a lock selectively locking the first arm to the third arm;
a hydraulic lock actuator operatively connected to the lock for unlocking the lock; and
second hydraulic lines fluidly connecting the first hydraulic lines to the hydraulic lock actuator.

6. The roll compactor attachment of claim 1, further comprising a lock selectively locking the first arm to the third arm.

7. The roll compactor attachment of claim 1, wherein:
a first distance between a lower end of the first arm and the first pivot axis is smaller than a second distance between the first pivot axis and the second pivot axis; and
the first distance is smaller than a third distance between the second pivot axis and an axis of rotation of the roller.

8. The roll compactor attachment of claim 1, wherein:
a first distance between a lower end of the first arm and the first pivot axis is smaller than a second distance between the first pivot axis and the second pivot axis; and
the second distance is smaller than a maximum distance between the second pivot axis and a circumference of the roller.

9. The roll compactor attachment of claim 1, wherein the roller has a plurality of cutters.

10. A loader comprising:
a frame;
a driver cabin mounted to the frame;
at least four wheels operatively connected to the frame;
a boom assembly pivotally mounted to the loader; and
the roll compactor attachment of claim 1 selectively connected to the boom assembly.

11. A roll compactor attachment for a loader comprising:
a first arm having a first end portion configured for connecting to a boom assembly of the loader;
a second arm having a first end portion pivotally connected to a second end portion of the first arm about a first pivot axis;
a third arm having a first end portion pivotally connected to a second end portion of the second arm about at second pivot axis;
a roller rotationally connected to a second end portion of the third arm;
a roller actuator operatively connected to the roller for turning the roller; and
a lock selectively locking the first arm to the third arm.

12. The roll compactor attachment of claim 11, further comprising a stopper connected to one of the first and second arms, the stopper selectively abutting another one of the first and second arms to limit a minimum angle between the first and second arms.

13. The roll compactor attachment of claim 11, wherein the first arm has two pins for connecting the first arm to the boom assembly.

14. The roll compactor attachment of claim 11, wherein the roller actuator is a rotary hydraulic motor.

15. The roll compactor attachment of claim 14, further comprising:
first hydraulic lines fluidly connected to the rotary hydraulic motor;
a hydraulic lock actuator operatively connected to the lock for unlocking the lock; and
second hydraulic lines fluidly connecting the first hydraulic lines to the hydraulic lock actuator.

16. The roll compactor attachment of claim 15, wherein actuating the rotary hydraulic motor actuates the hydraulic lock actuator to unlock the lock.

17. The roll compactor attachment of claim 11, wherein:
the lock comprises a hook connected to the first arm and a pin connected to the third arm; and
the hook selectively engages the pin to lock the first arm to the third arm.

18. The roll compactor attachment of claim 11, wherein:
a first distance between a lower end of the first arm and the first pivot axis is smaller than a second distance between the first pivot axis and the second pivot axis; and
the first distance is smaller than a third distance between the second pivot axis and an axis of rotation of the roller.

19. The roll compactor attachment of claim 11, wherein:
a first distance between a lower end of the first arm and the first pivot axis is smaller than a second distance between the first pivot axis and the second pivot axis; and
the second distance is smaller than a maximum distance between the second pivot axis and a circumference of the roller.

20. (canceled)

21. A loader comprising:
a frame;
a driver cabin mounted to the frame;
at least four wheels operatively connected to the frame;
a boom assembly pivotally mounted to the loader; and
the roll compactor attachment of claim 11 selectively connected to the boom assembly.
